(19) United States
(12) Patent Application Publication
(10) Pub. No.: US 2021/0339241 A1
(43) Pub. Date: Nov. 4, 2021

(54) HOUSING FOR A TEST STRIPE

(71) Applicant: Bühlmann Laboratories AG, Schönenbuch (CH)

(72) Inventors: Frank Bantleon, Basel (CH); Andreas Abel, Oberwil (CH); Jakob Weber, Pfeffingen (CH)

(73) Assignee: Bühlmann Laboratories AG, Schönenbuch (CH)

(21) Appl. No.: 17/282,063

(22) PCT Filed: Sep. 27, 2019
(86) PCT No.: PCT/EP2019/076228

§ 371 Date: Apr. 1, 2021

(30) Foreign Application Priority Data
Oct. 4, 2018 (EP) 18198703.3

(51) Int. Cl. B01L 3/00; B01L 9/00

(52) U.S. Cl. CPC B01L 3/5023; B01L 9/527; B01L 2200/025; B01L 2300/0825; B01L 2400/0406

(57) ABSTRACT

A test device (10) for testing a sample liquid with a test stripe (60), comprising the test stripe (60) comprising a backing (62) and an analytical membrane (64) in the centre portion of the backing, a housing comprising a housing base (20) and a housing lid (40), which are connected with each other, the housing base (20) comprises an accommodation portion (22) for accommodating the test stripe (60), the accommodation portion (22) comprises restricting elements (24) that restrict the movement of the test stripe (60) in y-direction, and the housing lid (40) comprises an inlet opening (42) for introducing the sample liquid into the housing, wherein the inlet opening (42) is located opposite to the accommodation portion (22), wherein the accommodation portion (22) of the housing base further comprises a plurality of lower bridges (26) on pre-defined positions for supporting the test stripe (60) and the housing lid (40) comprises a plurality of upper bridges (48) on pre-defined positions opposite to the accommodation portion (22).

### FIELD OF INVENTION

The invention relates to test devices for lateral flow test stripes for analyzing liquid samples.

### STATE OF THE ART

There are plenty of different test devices which include test stripes for analyzing liquids like blood. These devices comprise a housing with an accommodation portion in which the test stripe is placed and held by some shallow border portions. When the housing is assembled, the test stripe is held in its place. The housing comprises an inlet opening through which the sample liquid can be introduced into the test device. One problem is that once the liquid is dropped onto the test stripe, the liquid can sometimes have difficulties to proceed on the test stripe to the different test regions due to insufficient design and manufacturing quality of the housing-test stripe interactions. Additionally, the test stripes sometimes do not reliably stay in the accommodation portion and might slip out of position which might render that the test device is not usable or the test result is invalid.

### SUMMARY OF THE INVENTION

Object of the invention is to provide a test device that can reliably hold the test stripe in place. Furthermore, the test device should also enhance the advancement and proper distribution of the liquid within the test stripe and optimize test performance.

The object of the invention is achieved by the test device according to claim 1. Further preferred embodiments are depicted in the dependent claims.

A test device for testing a sample liquid with a test stripe according to the invention, comprises a test stripe having a backing and an analytical membrane in the centre portion of the backing, a housing having a housing base and a housing lid, which are connected with each other, wherein the housing base comprises an accommodation portion for accommodating the test stripe, the accommodation portion comprises restricting elements that restrict the movement of the test stripe to the side in y-direction of the test stripe and the housing lid comprises an inlet opening for introducing the sample liquid into the housing, wherein the inlet opening is located opposite to the accommodation portion, wherein the accommodation portion of the housing base further comprises a plurality of lower bridges on pre-defined positions for supporting the test stripe and the housing lid comprises a plurality of upper bridges on pre-defined positions opposite to the accommodation portion. The lower bridges and upper bridges provide a better stabilization of the test stripe by slightly pressing it against each other and furthermore also improve the liquid flow within the test stripe by compacting the different test stripe portions, in particular in the overlapping regions thereof.

At least two of the upper bridges are positioned adjacent to the membrane portion of the test stripe. This portion is the most beneficial for enhancing the liquid flow within the test stripe. The lower and upper bridges are preferably not located directly opposite of each other.

Preferably, the restricting element of the accommodation portion is formed as a wall on both sides and along the test stripe, wherein the wall is at least partially higher in z-direction than the upper edge of the analytical membrane of the test stripe, in particular partially contacting the inner surface of the housing lid. Making the wall higher than the test stripe will ensure that the test stripe cannot deviate sidewise (y-direction) from its position within the housing.

The accommodation portion further comprises stopper elements in x-direction to further restrict the movement in x-direction of the test stripe. That will further ensure that the liquid is introduced on the correct position of the test stripe and keeps the test stripe in its exact pre-determined position. Preferably, the stopper elements in x-direction are formed as a part of the wall of the housing base. In this case, the housing is on its inner side essentially as long as the test stripe.

The housing base can comprise a structural marker on the outside, in particular a recess or protrusion. Such a structural marker interacts with a reading or evaluation device to ensure that the test device is placed in the correct position on the evaluation device. In particular when the marker is placed asymmetrically on the surface of the housing base in view of the x- and/or y-direction, the correct position of the test device in a reading or evaluation device is determined in an easy way.

The inner surface of the housing lid is spaced apart from the analytical membrane of the test stripe. The space between the lid and the analytical membrane keeps the flow and the biochemical and biophysical reactions within the analytical membrane undisturbed.

Preferably, the housing base and the housing lid are fixed to each other by a plurality of connectors, in particular plugs and corresponding sockets, which are arranged asymmetrically on the inside of the housing base and the housing lid. This is a way to ensure the correct orientation of the housing base and the housing lid during manufacturing and assembly of the housings with the test stripe. The connectors of either the housing lid or the housing base can comprise stoppers to prevent that the housing elements are pushed together to hard and the test stripe gets compromised by the inner surface of the housing lid.

The test device can further comprise an indication marker for indicating whether the test stripe is correctly oriented within the accommodation portion. Such an indication marker can be a small coloured line or a small structural protrusion and it gives the assembly worker who mounts the test device a visual indication how to orient the test stripe within the accommodation portion.

Preferably, the inlet opening comprises at least one recess in z-direction at the circumferential edge for co-operation with protrusions on a corresponding sample liquid dispenser. Basically such a recess can be a mere cut-out at the circumferential edge. In a more detailed embodiment, the recess is formed as a guiding path having walls and a bottom to guide the protrusion of the sample liquid dispenser. The bottom also serves to take all the force into the housing lid to avoid that the test stripe gets damaged when the liquid dispenser is pressed down too hard. The recess can comprise a further slot formed rectangular to the z-direction on the bottom of the recess. In this way, there can be a hook shaped counterpart as a protrusion on the sample liquid dispenser and it keeps the protrusion locked in the recess. Such a recess can be referred to as a bayonet lock.

### BRIEF DESCRIPTION OF THE FIGURES

FIG. 1a shows an isometric view of the test device from the top side;

FIG. 1b shows an isometric view of the test device from bottom side;

FIG. 2a shows the housing lid in an isometric view from the bottom side;

FIG. 2b shows the housing base in an isometric view from the top side

FIG. 3a shows the housing base from a top view;

FIGS. 3b and 3c show a cross-section A-A and B-B of FIG. 3a;

FIG. 4a shows the test stripe in an isometric view from the top side;

FIG. 4b shows the test stripe in an isometric view from the bottom side;

FIG. 5a shows a longitudinal section through the assembled test device;

FIG. 5b shows an exploded view of a longitudinal section through the assembled test device; and

FIG. 6 shows the device and a sample collector in an isometric view from the top.

### DESCRIPTION OF THE PREFERRED EMBODIMENTS OF THE INVENTION

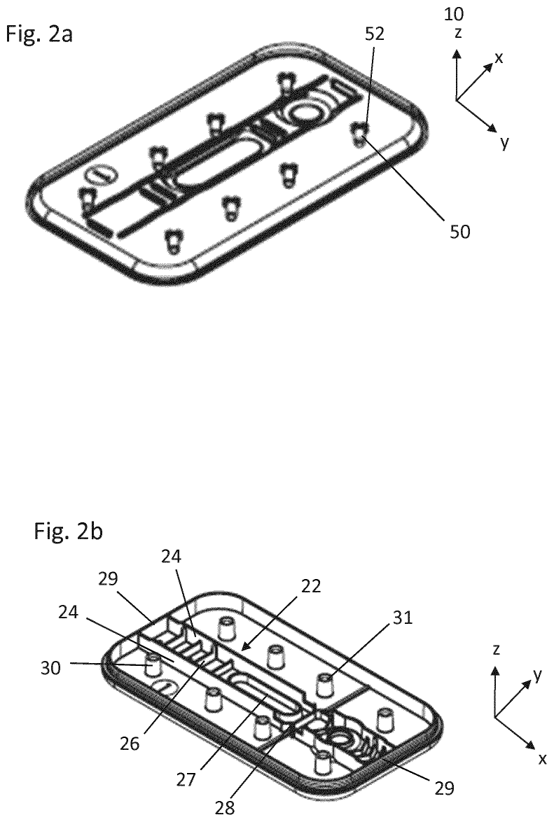

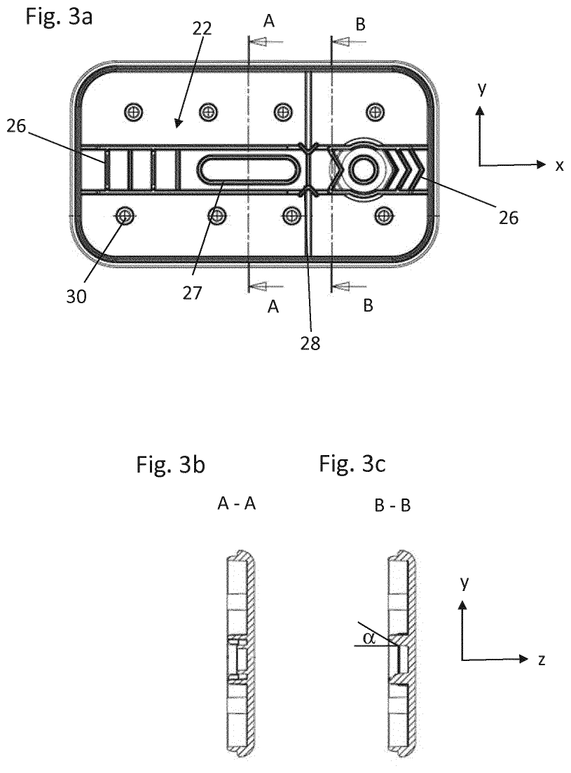

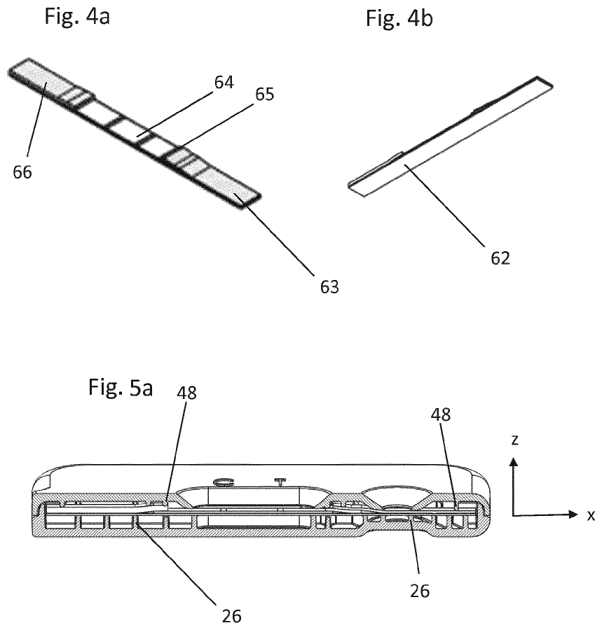

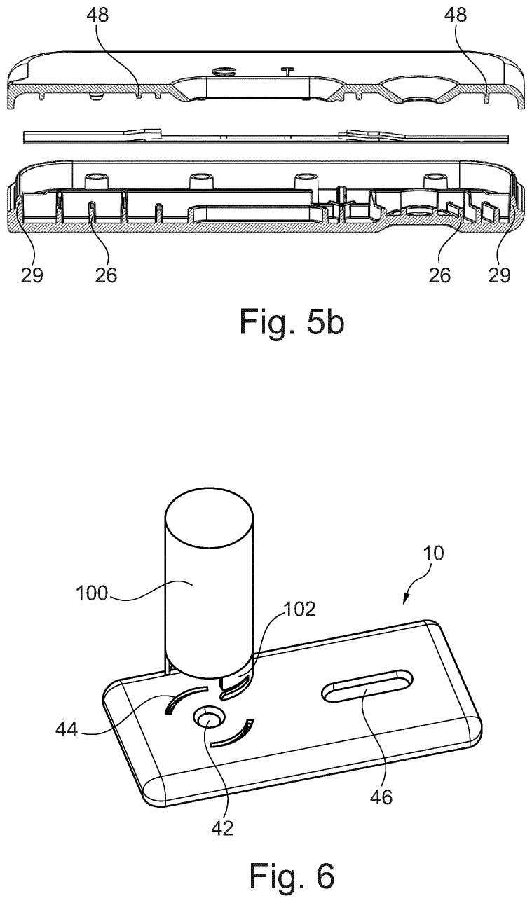

When in the following description directions like “up”, “down”, “left” or “right” are mentioned, they are referenced to the directions as in FIG. 2b, FIG. 3c and FIG. 4b if not otherwise specified. The direction “x”, “y” and “z” are defined by the coordinate system indicated in the figures.

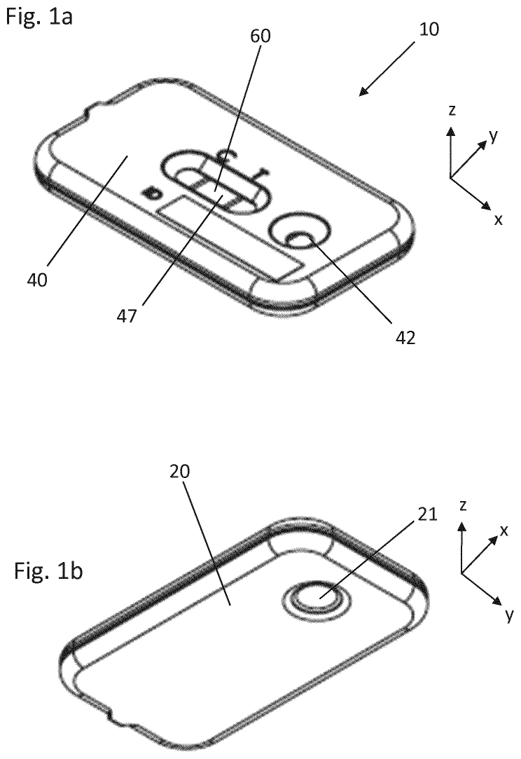

FIG. 1a and FIG. 1b show an isometric view of the test device 10. The test device 10 essentially comprises a housing having a housing base 20 and a housing lid 40 which are connected to each other. Furthermore, the test device 10 comprises a test stripe 60 with different portions. The general structure of the test stripe 60 is known by the skilled person. Commonly, it comprises a backing 62 on which all the other elements of the test stripe 60 are formed. The first portion is the sample application pad 63 on which the liquid sample is introduced into the test stripe 60. The main portion in which the test stripe analyses the liquid sample is the analytical membrane 64 which is connected by a conjugate release pad 65 to the sample application pad 63. Located on the opposite side of the analytical membrane 64 is a wicking pad 66 that serves as a waste container for the flow-through of the analysed sample. The thickest portion of the test stripe is the connection from the sample application pad 63 and conjugate release pad 65, respectively, to the analytical membrane 64. This portion is about 1.3 mm to 1.4 mm thick. The thinnest portion is the analytical membrane 64 which is in the range of 0.55 mm to 0.65 mm.

The test device 10 can generally have any shape. In the present embodiment, the housing lid 40 and the housing base 20 each have a rectangular base shape and four sidewalls. The edges are preferably rounded. The side walls of the housing base 20 and the housing lid 40 correspond to each other so that they tightly enclose an inner space.

In the base of the housing lid 40, there is an inlet opening 42 that enables the introduction of a sample liquid like, for instance, blood. Additionally, there is provided a visual opening 46 that is slightly elongated (about 1 to 2 cm) and has the purpose to make the membrane part 64 of the test stripe 60 visible from the outside of the housing. Adjacent to the inlet opening 42, there is provided a slit or recess 44 in the surface of the housing lid 40. This slit can for example be formed elongated and serves the purpose of receiving a protrusion of a liquid sample device or sample collector 100 on the outlet portion thereof. The slit or recess 44 preferably has a bottom on which the protrusion of the sample collector 100 can abut and guide the downward pressing forces into the housing, thereby avoiding that the test stripe gets damaged by the liquid sample device or sample collector. In a preferred embodiment, the slit or recess is provided for locking the protrusion on the liquid sample device with a bayonet lock. For this, the recess 44 adjacent to the inlet opening 42 is open at least in z direction and below the lid surface there is space in a direction rectangular to the z-direction so that the protrusion with the bayonet can be inserted in the recess 44 and twisted so that the hook is moved under the lid surface and cannot be retracted by simple pulling of the liquid sample device.

The inside of the housing lid 40 is shown in FIG. 2a. The inlet opening 42 and the visual opening 46 are visible and provided in the region in which the test stripe 60 is placed onto the housing base 20. The placement region for the test stripe 60 is preferably indicated by two elongated walls 47. Furthermore, upper bridges 48 extend in y-direction and are preferably placed between the two walls 47. The upper bridges firstly put pressure on the test stripe and in particular on the connections of the different portions (analytical membrane, conjugate release pad, sample application pad, wicking pad) so that the sample liquid dispensed onto the test stripe can optimally flow through the different portions. There is an ideal point of pressure which enhances the flowing behaviour of the liquid within the test stripe and does not restrict it. Secondly, the upper bridges 48 and lower bridges 26 stabilize the test stripe and prevent it from sliding out of position in the accommodation portion 22. It is particularly important that the upper bridges 48 do not touch the analytical membrane 64.

Further provided on the inner side of the housing lid 40 are upper connectors 50 which interact with corresponding lower connectors 30 on the inside of the housing base 20 and serve to fix the housing lid 40 on the housing base 20. Preferably, these connectors 50 are arranged asymmetrically in view of a longitudinal axis and, therefore, the housing lid and the housing base cannot be connected to each other in an incorrect way. The upper connectors 50 can, for instance, be formed as circular or polygonal shaped columns, although the shape does not matter for their function. Here, the upper connectors 50 are formed as a protruding pin, which comprise stabilizing stoppers 52 which are arranged on four sides of the upper connectors 50 opposite of each other. These stoppers (52) prevent that the housing elements touch the analytical membrane 64 when the housing base 20 and the housing lid 40 are pressed together and additionally prevent that the housing elements are pushed together to hard and the test stripe 60 gets compromised by the inner surface of the housing lid 40.

The housing base 20 comprises an accommodation portion 22 for accommodating the test stripe 60. On the lower outside of the housing base a structural marker 21 is provided for correctly placing the test device 10 on a reading device (not shown) for evaluating the test device. This marker is arranged asymmetrically, i.e. it is not placed on a symmetrical axis of the housing base. This ensures that the test device 10 can only be placed in the correct position onto the reading or evaluating device.

On the inside of the housing base corresponding lower connectors 30 are placed on locations opposed to the upper connectors 50. Here, the lower connectors 30 are also column-shaped and comprise a bore or hole 31 in which the upper connectors 50 will be pushed into and fixed. The accommodation portion 22 keeps the test stripe in place, for example by two restricting elements formed as side walls 24. These side walls 24 restrict the movement of the test stripe in y-direction. Furthermore, the movement of the test stripe 60 can also be restricted by stopper elements 29 in x-direction. In the embodiment shown in the figures, the stopper elements 29 are part of the housing walls of the housing base 20, i.e. the inner distance from the housing walls in x-direction of the housing base 20 is essentially the same or at least less than 1 mm longer as the length of the test stripe 60.

Located between the side walls 24 are bridges 26 which again serve to support correct positioning of the test stripe 60 and to put pressure on it. The lower bridges 26 of the housing base 20 are preferably not directly opposite to the upper bridges 48 of the housing lid 40. By this, it is avoided that the bridges are pressing the test stripe 60 simultaneously from above and below and therefore hinder the flow of the sample liquid through the test stripe. The closest distance of the upper bridges 48 and lower bridges 26 for the test stripe 60 as described is preferably at least 1.1 mm, more preferred 1.2 mm or 1.3 mm, and at most 1.6 mm, 1.5 mm or 1.4 mm. In the described example, the distance is essentially 1.35 mm. The lower bridges 26 interacting with the sample application pad 63 and conjugate release pad 65, respectively, of the test stripe 60 are preferably formed arrow-shaped, whereas the bridges supporting the wicking pad portion 66 are formed straight. The support element 27 for the analytical membrane 64 is rectangular with rounded or circular end portions as shown in FIG. 3a.

The lower bridges 26 are preferably more closely located to the support element 27 for the analytical membrane 64 than the upper bridges 48 to ensure that the upper bridges 48 do not touch the analytical membrane 64. Furthermore, in the housing base 20 is provided an indication marker 28 that indicates the direction of placement of the test stripe. For example, during manufacturing of the test device 10, the test stripe 60 is manually put into the housing base 20, and there is the risk that the test stripe 60 is put with the wicking pad portion 66 under the inlet opening 42 into the accommodation portion 22. This can be prevented, if the test device comprises an indication marker 28 that indicates how the test stripe has to be placed into the accommodation portion 22. Preferably, the test stripe has a marker or any other distinctive feature so that the worker can easily spot with which side the test stripe 60 has to be put in the accommodating portion. In the present embodiment, there is a red mark on the test stripe 60. The indication marker 28 in the housing base 20 is a bridge with arrow-shaped sides which is located next to the support element 27. But generally, it can also be just a coloured marker at the indication marker position 28 or being placed outside of the side walls 24. Furthermore, a part of the side walls 24 of the accommodation portion 22 can be inclined to ease the assembly of the test stripe into the accommodation part 22 of the housing base 20. In the present embodiment the inclining portion is formed on the arrow-shaped indication marker 28. The inclination is preferably between 20° and 30° degrees, more preferably essentially 25° degrees.

The test device 10 is manufactured by taking a housing base 20, putting the test stripe 60 into the accommodation portion 22 while checking whether the test stripe 60 is placed correctly by checking the alignment of the test stripe in respect to the indication marker 28. Then the housing lid 40 is placed on the housing base 20 so that the lower connectors 30 and the upper connectors 50 align and can be fixed into each other.

In use, the liquid sample is taken by a sample collecting device 100. If the test device comprises slits or recesses 44, the respective protrusions 102 are introduced in the recesses 44 and, if it is a bayonet lock as shown in FIG. 6, twisted correspondingly. The liquid flows through the inlet opening 42 onto the sample application pad 63. Frome there, the liquid travels inside the test stripe over the conjugate release pad 65 to the analytical membrane 64 and reacts with the reagents deposited onto the analytical membrane. The superfluous reactants are then further travelling to the wicking pad 66. The test device 10 can then be placed into a reading or evaluation device and the results of the test are measured, calculated and shown by the evaluation device.

### REFERENCE NUMBERS

test device 10

housing base 20

structural marker 21

accommodation portion 22

side walls 24

lower bridges 26

support element 27

indication marker 28

stopper elements 29

lower connectors 30

connector bore/hole 31

housing lid 40

lid surface 41

inlet opening 42

slit/recess 44

visual opening 46

elongated wall 47

upper bridges 48

upper connectors 50

stoppers 52

test stripe 60

backing 62

sample application pad 63

analytical membrane 64

conjugate release pad 65

wicking pad 66

sample collector 100

protrusion 102

1. Test device (10) for testing a sample liquid with a test stripe (60), comprising
the test stripe (60) comprising a backing (62) and an analytical membrane (64) in the centre portion of the backing;
a housing comprising a housing base (20) and a housing lid (40), which are connected with each other;
the housing base (20) comprises an accommodation portion (22) for accommodating the test stripe (60), the accommodation portion (22) comprises restricting elements (24) that restrict the movement of the test stripe (60) in y-direction; and
the housing lid (40) comprises an inlet opening (42) for introducing the sample liquid into the housing, wherein the inlet opening (42) is located opposite to the accommodation
portion (22); wherein the accommodation portion (22) of the housing base further comprises a plurality of lower bridges (26) on pre-defined positions for supporting the test stripe (60) and the housing lid (40) comprises a plurality of upper bridges (48) on pre-defined positions opposite to the accommodation portion (22).

2. Test device (10) according to claim 1, wherein at least two of the upper bridges (48) are positioned adjacent to the membrane portion of the test stripe.

3. Test device (10) according to claim 1, wherein the restricting elements (24) of the accommodation portion (22) are formed as side walls on both sides of and along the test stripe (60), wherein the side walls (24) are at least partially higher in z-direction than the upper edge of the analytical membrane (64) of the test stripe (60).

4. Test device (10) according to claim 1, wherein the accommodation portion (22) further comprises stopper elements (29) in x-direction to further restrict the movement of the test stripe in x-direction.

5. Test device (10) according to claim 4, wherein the longitudinal stopper elements (29) are formed as a part of the wall of the housing base (20).

6. Test device (10) according to claim 1, wherein the housing base (20) comprises a structural marker (21) on the outside.

7. Test device (10) according to claim 6, wherein the structural marker (21) is placed asymmetrically on the surface of the housing base in view of the x- and/or y-direction.

8. Test device (10) according to claim 1, wherein the inner surface of the housing lid (40) is spaced apart from the analytical membrane.

9. Test device (10) according to claim 1, wherein housing base (20) and the housing lid (40) are fixed to each other by a plurality of connectors (30, 50), which are arranged asymmetrically on the inside of the housing base (20) and the housing lid (40).

10. Test device (10) according to claim 9, wherein the connectors (30, 50) of either the housing lid or the housing base comprise stoppers (52).

11. Test device (10) according to claim 1, further comprising an indication marker (28) for indicating whether the test stripe is correctly oriented within the accommodation portion (22).

12. Test device (10) according to claim 1, wherein the inlet opening (42) comprises at least one recess (44) in z-direction at the circumferential edge for co-operation with protrusions (102) on a corresponding sample liquid dispenser (100).

13. Test device (10) according to claim 11, wherein the recess (44) comprises a further slot formed rectangular to the z-direction in the recess (44).
